(19) United States
(12) Patent Application Publication
(10) Pub. No.: US 2017/0275802 A1
(43) Pub. Date: Sep. 28, 2017

(54) WASHING MACHINE HAVING REMINDING FUNCTION FOR PREVENTING CLOTHING FROM FADING AND METHOD

(71) Applicant: QINGDAO HAIER WASHING MACHINE CO., LTD., Laoshan, Qingdao, Shandong (CN)

(72) Inventors: Sheng XU, Laoshan, Qingdao, Shandong (CN); Junming YIN, Laoshan, Qingdao, Shandong (CN); Yuling CHEN, Laoshan, Qingdao, Shandong (CN); Huacheng SONG, Laoshan, Qingdao, Shandong (CN)

(73) Assignee: QINGDAO HAIER WASHING MACHINE CO., LTD., Laoshan, Qingdao, Shandong (CN)

(21) Appl. No.: 15/505,961

(22) PCT Filed: Nov. 14, 2014
(86) PCT No.: PCT/CN2014/091147

§ 371 Date: Feb. 23, 2017

(30) Foreign Application Priority Data
Aug. 28, 2014 (CN) 201410438739.0

(51) Int. Cl. D06F 39/00; G01N 21/85; D06F 39/08

(52) U.S. Cl. CPC D06F 39/004; D06F 39/088; G01N 21/85; D06F 2202/02

(57) ABSTRACT

A washing machine having a reminding function for preventing clothing from fading, comprising: an outer drum for accommodating washing water; a color sensor arranged on the washing machine and detecting the color of the washing water, so that according to changes in the color of the washing water in a washing process, it is determined whether the clothing being washed is fading or not. Detection of the color of the washing water achieves the aim of determining, according to the changes in the color of the washing water, whether the clothing being washed is fading or not, thereby improving the sensitivity and accuracy of determination, and preventing a situation wherein fading clothing contaminates the washing water then causes secondary contamination of other clothing being washed.

### FIELD OF THE INVENTION

The present disclosure relates to a field of washing machine, particularly to a washing machine having reminding function for preventing clothing from fading, and relates to a reminding method of a washing machine for preventing clothing from fading.

### BACKGROUND OF THE INVENTION

With the development of sensor technology, more and more sensors are used in the washing machine, so that washing machines are more and more intelligent. For example, the existing washing machine is gradually equipped with turbidity sensor, temperature sensor, washing machine weighing module and so on. These sensors make the washing machine have a certain interaction to the washing environment, so the washing machine has taken one step to intelligent.

However, the existing washing machine can't identify the color of clothes. When the color clothes being put into the washing machine, the color fading phenomenon will occur as the washing process goes. If there is no corresponding detection device to detect it, the fading phenomenon will continue to occur, resulting in increased damage to clothes, and ultimately causing irreparable damage to clothes. This not only causes users to lose a beloved clothing, more likely the users will blame the washing machine and have a psychological conflict to the washing machines of certain brand.

In order to achieve early warning and detecting of the color fading phenomenon of clothing in the existing washing machine, the existing literature proposed a number of improvements. For example, Chinese patent application No. CN200780025027.4 discloses a washing machine, which is installed a color sensor at the clothes disposal of the washing tub. During the delivery of the laundry, the color sensor detects the color of the laundry, and the controller determines the washing parameters based on the color data of the laundry. The washing machine then washes the laundry according to the determined washing parameters.

But the scheme described above only separates washing based on the color of the clothes, thus ensures that the color fading phenomenon will not occur between different color clothes, and the contamination between clothes will not occur. By adopting the scheme described above, the washing machine sends the wrong fading alarm when different color and not easy color fading clothes are washed at the same time. And it results in the user error interpretation, and affects the normal washing process.

In view of the foregoing, the present disclosure is proposed.

### SUMMARY OF THE INVENTION

An objective of the present disclosure is to provide a washing machine having a reminding function for preventing clothing from fading, so as to achieve the fading detection of clothing.

To achieve the objective of the disclosure, a technical scheme is adopted as followed.

A washing machine having a reminding function for preventing clothing from fading comprises an outer tub for washing water. The washing machine is provided with a color sensor for detecting color of washing water to judge whether or not the laundry is faded depending on color change of the washing water during a washing process.

Further, the washing machine is equipped with a LED light emitting a white detection light which corresponds with the color sensor. The white detection light emitted by the LED light is passed through the washing water to the color sensor, and the color sensor obtains the color of the washing water based on the received detection light color.

Further, a bottom of the outer tub is provided with a sampler which communicates with the outer tub for influent of the washing water. Both side walls of the sampler are equipped with LED lights and color sensor respectively. The white detection light emitted by the LED light is passed through the washing water in the sampler to the color sensor, and the color sensor obtains the color of the wash water based on the received detection light color.

Further, the sampler is arranged on a drain pipe or a circulation pipe of the washing machine. And the sampler is arranged upstream of a control device which controls the opening and closing of the drain pipe or the circulation pipe, and the washing water in the outer tub is controlled to flow outside the washing machine through the sampler or into the washing machine though an inlet.

Further, a connecting pipe is communicated with the outside of the washing machine through the drain pipe or communicated with the inlet of the washing machine through the circulating pipe.

Further, the sampler comprises a housing configured a chamber for receiving a certain amount washing water. An upper end of the housing is provided with a water inlet connected with the outer tub. A lower end of the housing is communicated with the drain pipe or the circulating pipe of the washing machine through the connecting pipe. The connecting pipe is provided with a control device for controlling the opening and closing of the pipeline.

Further, the LED light and the color sensor are relatively provided on left and right side walls of the housing of the sampler to detect the color of the washing water in the sampler. A portion of the housing corresponding to the LED light and a portion of the housing corresponding to the color sensor are respectively a transparent portion made of a light-transmitting plate.

Further, a bowl-shaped reflective plate is provided around a periphery of the LED light which reflects a divergent white light emitted from the LED light as a parallel light to a receiving component. A convex lens is provided between the color sensor and the light-transmitting plate on a corresponding side, and the parallel detection light passing through the washing water is focused to the color sensor.

Further, a lens hood made of an opaque material is provided around an outer periphery of the color sensor. Preferably, the lens hood and the light-transmitting plate on the corresponding side constitute an enclosed chamber for placing the receiving component. Further preferably, the housing of the sampler is made of opaque material to form a shading portion.

Further, the color sensor comprises a detection element and filters which can filter red, green and blue colors respectively, so as to obtain a value of red color R, a value of green color G, and a value of blue color B that is contained in the washing water.

Further, all the filters are provided on a side of the detection element facing the detection light. The red filter, the green filter and the blue filter are respectively provided in different areas so that the detection element can receive the detection light containing only red light, green light and blue light after filtration.

By the means of the above-described apparatus, the present disclosure employs another way to detect the clothing color fading which is different from the prior art such as in the patent application No. CN200780025027.4.

The sampler for the washing water is arranged at a bottom of the outer tub of the washing machine. A sample the washing water is taken at a time interval, and a white LED light emits light to the sampler and the color sensor receives the light through the sampler then sends the detection value to the processor of the washing machine. Comparing a detection value to a set value by a processor, the purpose of determining whether or not the color fading of the clothing occurs is achieved. Thus achieves the purpose of timely prediction of the clothing color fading and a fast, sensitive determination of the clothing color fading.

Another objective of the present disclosure is to provide a reminding method of a washing machine for preventing clothing from fading to fast, accurately determine whether or not the clothing color fading occurs. To achieve the purpose of the objective, a following technical scheme is adopted.

A reminding method of a washing machine for preventing clothing from fading, comprises, during a washing process of a washing machine, the washing machine detecting a color value of the washing water; when a change rate of a color value of the washing water is greater than a set value, issuing an alarm of clothing color fading.

Further, during the washing process, the color of the washing water in the outer tub of the washing machine is detected at a regular time interval t to get the color value of the washing water.

Further, during the washing process, a small amount of washing water in the outer tub of the washing machine flows out at a regular time interval t and the color of the outflowing washing water is detected to get the color value of the washing water at this time.

Further, the washing water in the sampler which is communicated with the outer tub of the washing machine is refreshed at a regular time interval t, and color of the refreshing washing water is detected by using the LED light and the color sensor which are arranged at the sampler.

Further, the control device at an out let of the sampler is open for a certain time t1 at a regular time interval t, to drain the washing water in the sampler out, and allow the washing water in the outer tub flow in through the water inlet of the sampler to refresh the washing water in the sampler.

Further, specific control steps of the washing process of the washing machine are following:

1) Comparing the color change rate of the washing water to the set value, if the change rate is smaller than the set value, running step 4), if the change rate is greater or equal to the set value, running step 2);

2) The washing machine alarming to users about clothing color fading and stopping washing, and running step 3);

3) The user determining whether or not to go on washing, if yes, running step 4), if no, running step 5);

4) The washing machine continuing proceeding the washing process; after a certain time t, running step 1) until the washing process ends, and then running step 5);

5) The washing machine proceeding draining, dewatering in turn; after the dewatering process ends, the washing machine being turned off.

Further, after the control device is closed, the LED light and the color sensor at the sampler are turned on, and the color of refreshing washing water is detected. After the detection is completed, turn off the LED light and the color sensor.

Further, the specific determination process is as followed. The LED emits white detection light to the washing water in the sampler; the detection light changes color after passing through the washing water; the color sensor receives the detection light though the washing water to determine the color of the washing water according to the color of the detection light received.

Further, the color sensor let the detection light which passes though the washing water and of which color has been changed respectively pass through red, green and blue three colors filters to get the color value of the red color R, the color value of the green color G, the color value of the blue color B that is contained in the washing water.

Further, the determination steps of the color fading of clothing are as followed,

11) Detecting the color value of the red color R, the color value of the green color G, the color value of the blue color B at a regular time interval t, and each detection value is sequentially stored as R1, R2 . . . Rn and G1, G2 . . . Gn and B1, B2 . . . Bn (n is a positive integer greater than 1) according to the detection time order;

12) The color values Rₙ, Gₙ, and Bₙ detected this time being correspondingly subtracted the previously detected color value values Rₙ₋₁, Gₙ₋₁ and Bₙ₋₁ to obtain ΔRₙ=|Rₙ−Rₙ₋₁|, ΔGₙ=|Gₙ−Gₙ₋₁|, ΔBₙ=|Bₙ−Bₙ₋₁|;

13) Comparing color change values ΔRₙ, ΔGₙ, ΔBₙ to corresponding set values ΔR′, ΔG′, ΔB′,

if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

Further, the determination steps of color fading of clothing are as followed,

21) During a water supplying process, or after the water supplying process and before the washing process, detecting the color of the washing water and getting initial color values R₀, G₀, B₀ of red, green and blue colors which is contained in the washing water;

22) During the washing process, respectively detecting the color value of the red color R, the color value of the green color G, the color value of the blue color B contained in the washing water at a regular time interval t;

23) The color values Rₙ, Gₙ, and Bₙ detected this time being correspondingly subtracted the initial color values R₀, G₀, B₀ before washing process to obtain ΔRₙ=|Rₙ−R₀|, ΔGₙ=|Gₙ−G₀|, ΔBₙ=|Bₙ−B₀|;

24) Comparing color change values ΔRₙ, ΔGₙ, ΔBₙ to corresponding set values ΔR′, ΔG′, ΔB′,

if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

Further, when ΔRₙ>ΔR′, the washing machine issuing a red alarm of clothing color fading,

when ΔGₙ>ΔG′, the washing machine issuing a green alarm of clothing color fading,

when ΔBₙ>ΔB′, the washing machine issuing a blue alarm of clothing color fading.

By adopting the above-described method, the present disclosure employs another way to detect the clothing color fading which is different from the prior art, such as the patent application No. CN200780025027.4.

The purpose of determining whether the laundry in the washing machine fades or not is achieved by monitoring the color of the washing water in the outer tub of the washing machine and by determining a relationship between the change rates of the color values of the washing water and the set values. Whereby, it is achieved to improve of the accuracy of the fading alarm, avoid the error determination and error alarm in the fading alarm of the washing machine.

By adopting the technical scheme described above, the present disclosure has the advantage over the prior art:

1. By detecting the color of the washing water, it is possible to determine whether or not the laundry fades according to the color change of the washing water, and to improve the sensitivity and accuracy of the determination. It also avoids the situation in which fading clothes pollutes on the washing water and then causes other washing clothes to be polluted secondary.

2. By detecting the change of the color value of the red, green and blue of the washing water separately, the color of the faded clothes can be obtained. User can fast determine the faded clothing.

3. Whether the laundry is color faded or not is determined by comparing the difference between the color detection value at present and the previous color detection value or the difference between the color detection value at present and the initial color detection value to the set value, and the accuracy of the alarm preventing clothing from fading in the washing machine is improved.

4. By providing the control device at the water outlet of the sampler so that the washing water in the sampler can be automatically controlled to refresh and ensure the accuracy of the color detection of the washing water.

5. The present disclosure has the advantages of simple structure, simple method, remarkable effect and suitable for popularization and use.

### BRIEF DESCRIPTION OF THE DRAWINGS

FIG. 1 and FIG. 2 are schematic views of a structure of a washing machine of the present disclosure;

FIG. 3 is an enlarged schematic view of the sampler of FIG. 2 of the present disclosure;

FIG. 4 is a schematic structural view of the cross section A-A of FIG. 3 of the present disclosure;

FIG. 5 is a flow chart of a reminding process of the clothing color fading of the present disclosure;

FIG. 6 is a flow chart of a judgment process of the clothing fading of the present disclosure;

FIG. 7 is a flow chart of a reminding process of the clothing fading of another embodiment of the present disclosure;

FIG. 8 is a flow chart of a determination process of the clothing fading of another embodiment of the present disclosure;

FIG. 9 is flow chart of a judgment process of the clothing fading of the present disclosure.

### MAJOR COMPONENTS DESCRIPTION

1—shell, 2—outer drum, 3—inner drum, 4—sampler, 5—color sensor, 6—LED light, 7—connecting pipe, 8—check valve, 9—draining pump, 41—housing, 42—light-transmitting plate, 43—water inlet, 44—water outlet, 51—lens hood, 52—convex lens, 53—red filter, 54—green filter, 55—blue filter, 61—reflective plate

### DETAILED DESCRIPTION OF THE INVENTION

The following is further described in details with embodiments of the present disclosure.

A washing machine can be any existing drum washing machine or pulsator washing machine. In order to facilitate the description of the following, a drum washing machine is taken as an example. The washing machine comprises a shell 1, an outer drum 2 mounted inside the shell 1, an inner drum 3 mounted in the outer cylinder 2, the axis of the inner drum is at an acute angle or coincident with the vertical direction. A color sensor 5 which detects color of washing water is provided on the washing machine, and judges whether the laundry is fading or not according to the color change of the washing water during the washing process.

### Embodiment 1

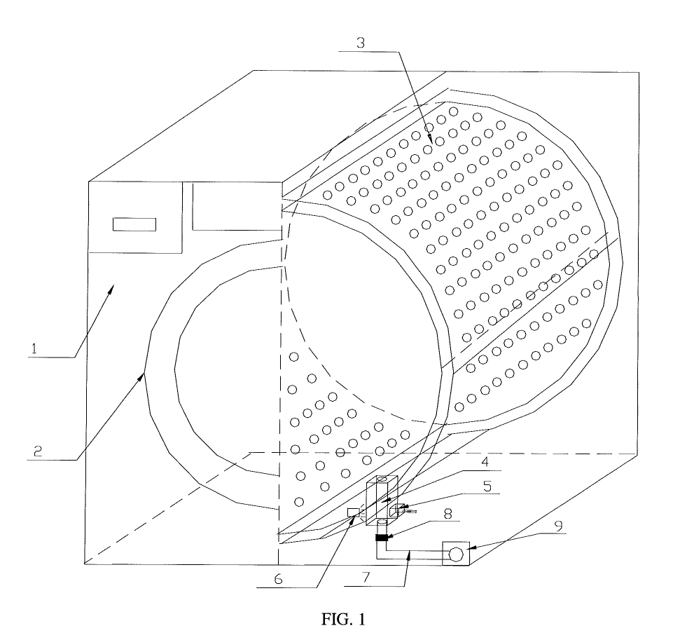

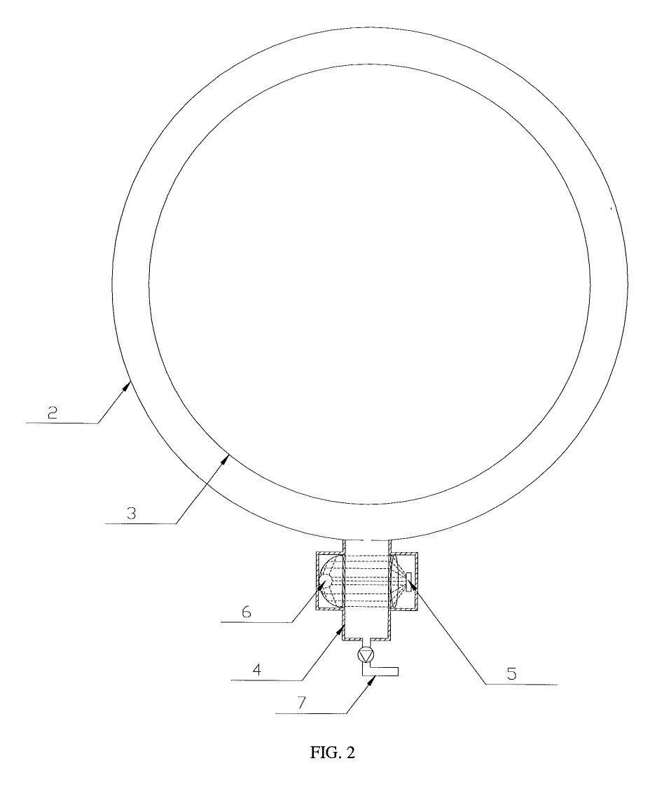

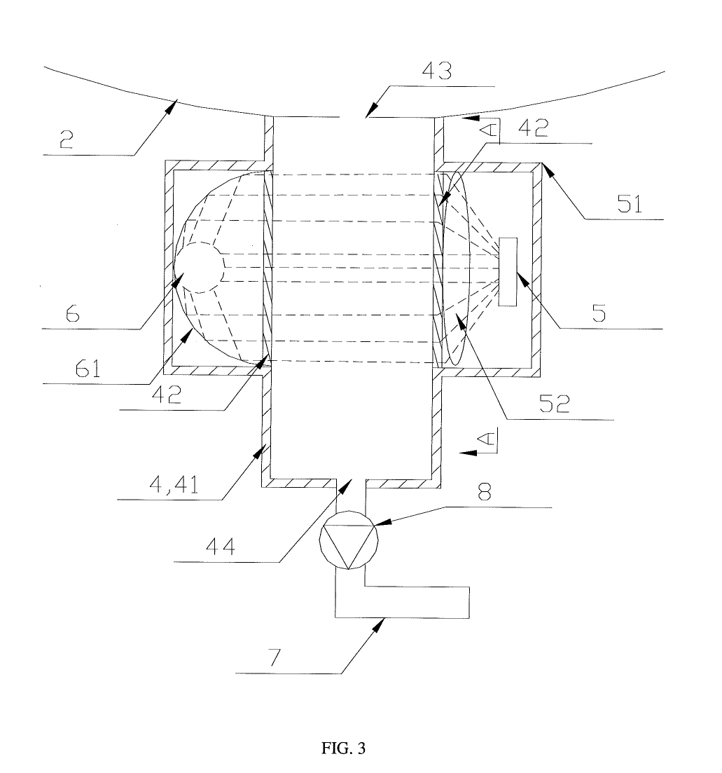

As shown from FIG. 1 to FIG. 2, in the present embodiment, a sampler 4 which is communicated with an inside of the outer drum 2 and let the washing water flow in is arranged at a bottom of the outer drum 2. The sampler 4 comprises a housing 41 configured a chamber for receiving a certain amount washing water. An upper end of the housing 41 is provided with a water inlet 43 communicated with the inside of the outer drum. A lower end of the housing 41 is communicated with the drain pipe or the circulating pipe of the washing machine through the connecting pipe 7 to drain the washing water in the housing 41 out of the washing machine or re-flow into the outer drum of the washing machine. Preferably, in the present embodiment, the connecting pipe 7 is communicated with the drain pipe. One end of the connecting pipe 7 is communicated with the water outlet 44 of the sampler 4, and other end is communicated with a water outlet of the draining pump 9 which is arranged in the drain pipe. The connecting pipe 7 is provided with a control device for controlling the opening and closing of the pipeline. Preferably, in the present embodiment, the control device is constituted by a check valve 8.

In the present embodiment, left side wall and right side wall of the housing 41 of the sampler 4 are respectively arranged LED light 6 and color sensor 5 corresponding to each other. The white detection light emitted by the LED light 6 is passed through the washing water in the sampler 4 to the color sensor 5, and the color sensor 5 obtains the color of the washing water based on the received detection light color.

In the present embodiment, the housing 41 of the sampler 4 is made of opaque material to form a shading portion. A portion of the housing 41 corresponding to the LED light 6 and a portion of the housing corresponding to the color sensor 5 are respectively a transparent portion made of a light-transmitting plate 42, thus ensures the detection light received by the color sensor 5 is all emitted by the LED light 6 and passing through the washing water.

In the present embodiment, a bowl-shaped reflective plate 61 is provided around a periphery of the LED light 6, which reflects a divergent white light emitted from the LED light 6 as a parallel light to the color sensor 5. Preferably, the focus of the bowl-shaped reflective plate 61 coincides with the center of the LED light 6 to improve the intensity of the detection light and to ensure the accuracy of the inspection.

In the present embodiment, a convex lens 52 is provided between the color sensor 5 and the light-transmitting plate 42 on a corresponding side, and the parallel detection light passing through the washing water in the sampler 4 is focused to the color sensor 5 to improve the collection efficiency of the color sensor 5 for detecting light. A lens hood 51 made of an opaque material is provided around an outer periphery of the color sensor 5. Preferably, the lens hood 51 and the light-transmitting plate 42 on the corresponding side constitute an enclosed chamber for placing the color sensor 5.

### Embodiment 2

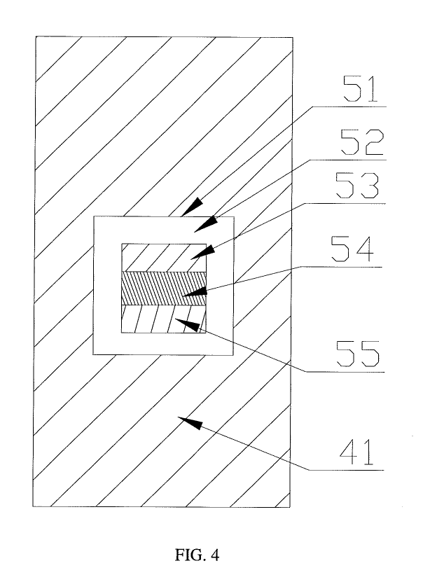

As shown in FIG. 4, in the present embodiment, the color sensor 5 comprises a detection element, and a red filter 53, a green filter 54 and a blue filter 55 for filtering three colors light of red, green and blue, so as to obtain a value of red color R, a value of green color G, a value of blue color B that are contained in the washing water

All the filters are provided at a front end of the detection light of the detection element. The red filter, the green filter and the blue filter are respectively provided in different areas so that the detection element can receive the detection light containing only red light, green light or blue light after filtration. Preferably, in the present embodiment, a red filter 53, a green filter 54, and a blue filter 55 are provided in this order from the top to the bottom at one side of the detection element. Thus, the color sensor is allowed to receive the detection light containing only red, green or blue respectively, to obtain the color value of the red color R, the color value of green color G, and the color value of blue color B contained in the washing water.

### Embodiment 3

The present embodiment discloses a reminding method of a washing machine for preventing clothing from fading: detecting a color of the washing water. When a change rate of a color value of the washing water is greater than a set value, an alarm of clothing color fading is issued.

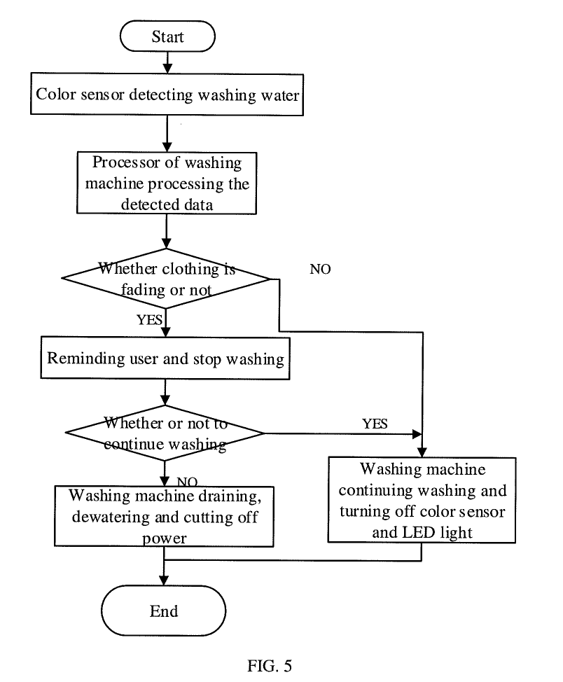

As shown in FIG. 5, specific steps of the method described above are as followed:

1) Comparing the color change rate of the washing water to the set value, if the change rate is smaller than the set value, running step 4); if the change rate is greater or equal to the set value, running step 2);

2) The washing machine alarming to users about clothing color fading and stopping washing, and running step 3);

3) The user determining whether or not to go on washing, if yes, running step 4); if no, running step 5);

4) The washing machine continuing proceeding the washing process; after a certain time t, running step 1) until the washing process ends, and then running step 5);

5) The washing machine proceeding draining, dewatering in turn; after the dewatering process ends, the washing machine turning off.

In the present embodiment, during the washing process, the color of the washing water is detected at a regular time interval t to get the color value of the washing water. Preferably, the washing water in the sampler which is communicated with the outer tub of the washing machine is refreshed at a regular time interval t, and the color of the refreshing washing water is detected by using the LED light and the color sensor which are arranged at the sampler. Further preferably, the control device at an out let of the sampler is open for a certain time t1 at a regular time interval t to drain the washing water in the sampler out, and allow the washing water in the outer tub to flow in through the water inlet of the sampler, so as to refresh the washing water in the sampler.

As show in FIG. 5, in the present embodiment, after the control device is closed, the LED light and the color sensor at the sampler are turned on, and detect the color of refreshing washing water. After the detection is completed, turn off the LED light and the color sensor.

In the present embodiment, the specific determination process is as followed. The LED light emits white detection light to the washing water in the sampler, the detection light changes color after passing through the washing water, the color sensor receives the detection light though the washing water to determine the color of the washing water according to the detection light received.

Preferably, in the present embodiment, the color sensor let the detection light which passes though the washing water and of which color has been changed respectively pass through red, green and blue three colors filters to get the color value of the red color R, the color value of the green color G, the color value of the blue color B that are contained in the washing water.

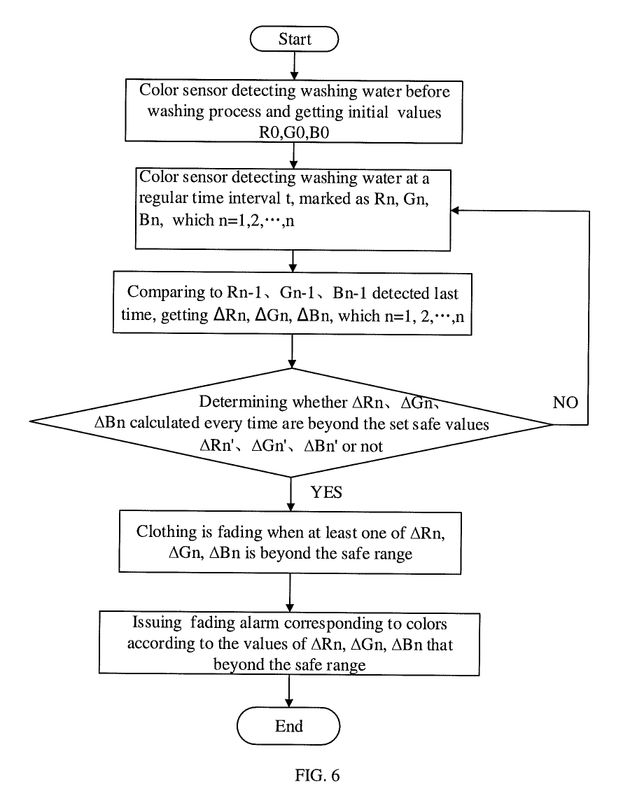

As show in FIG. 6, in the present embodiment, the determination steps of the color fading are as followed:

11) Detecting the color value of the red color R, the color value of the green color G, and the color value of the blue color B at a regular time interval t;

12) The color values Rₙ, Gₙ, and Bₙ detected this time being correspondingly subtracted the previously detected color value values Rₙ₋₁, Gₙ₋₁ and Bₙ₋₁ to obtain ΔRₙ=|Rₙ−Rₙ₋₁|, ΔGₙ=|Gₙ−Gₙ₋₁|, ΔBₙ=|Bₙ−Bₙ₋₁|;

13) Comparing color change values ΔRₙ, ΔGₙ, ΔBₙ to corresponding set values ΔR′, ΔG′, ΔB′,

if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

In the present embodiment, preferably, before washing process of the washing machine, the washing water is subjected to color detection to obtain an initial value. The corresponding set values ΔR′, ΔG′, ΔB′ are selected by the initial value to avoid the determination error of the detection result caused by the detergent color or the color of the washing water itself.

### Embodiment 4

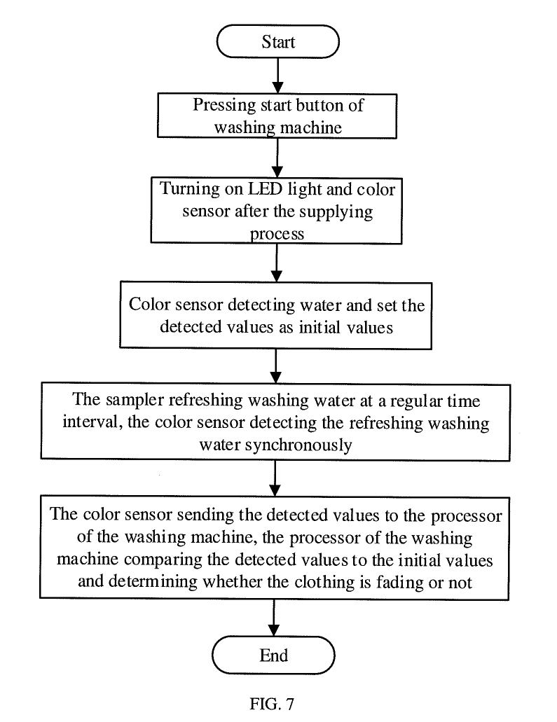

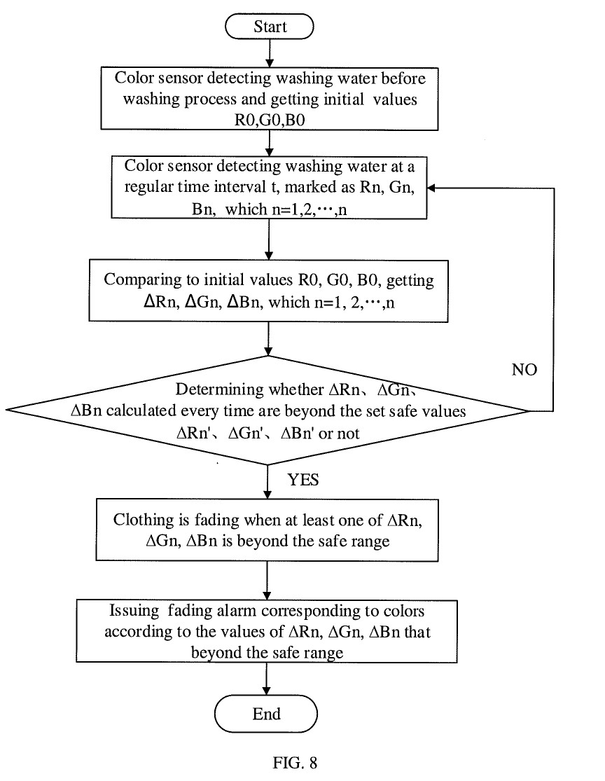

As shown in FIG. 7 and FIG. 8, in the present embodiment, the specific determination steps of color fading are as followed:

21) During a water supplying process, or after the water supplying process and before the washing process, detecting the color of the washing water and getting initial color values R₀, G₀, B₀ of red, green, blue colors which is contained in the washing water;

22) During the washing process, respectively detecting the color value of the red color R, the color value of the green color G, and the color value of the blue color B at a regular time interval t;

23) The color values Rₙ, Gₙ, and Bₙ detected this same time being correspondingly subtracted the initial color values R₀, G₀, B₀ before washing process to obtain ΔRₙ=|Rₙ−R₀|, ΔGₙ=|Gₙ−G₀|, ΔBₙ=|Bₙ−B₀|;

24) Comparing color change values ΔRₙ, ΔGₙ, ΔBₙ to corresponding set values ΔR′, ΔG′, ΔB′,

if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

The rate of change is obtained by directly comparing the color detection value of washing water with the initial value to adapt to a washing situation of the washing machine using different color detergent and/or washing water, to avoid the occurrence of error situation in the measurement results.

In the present embodiment, when ΔRₙ>ΔR′, the washing machine issues a red alarm of clothing color fading,

when ΔGₙ>ΔG′, the washing machine issues a green alarm of clothing color fading,

when ΔBₙ>ΔB′, the washing machine issues a blue alarm of clothing color fading.

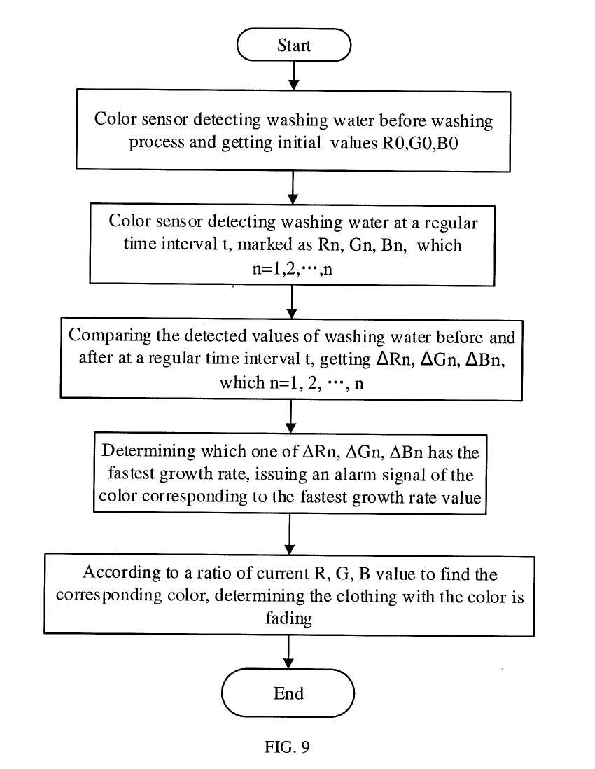

Further, as shown in FIG. 9, when at least two of the values ΔRₙ, ΔGₙ and ΔBₙ are both larger than the corresponding set values, the magnitude relationship between ΔRₙ, ΔGₙ and ΔBₙ is determined and an alarm of the color fading to which the maximum value corresponds to is issued. Or alarms of color fading to which each excess value corresponds are issued at the same time, and prompts users the alarm information of the color fading to which the maximum value corresponds.

Further preferably, when at least two of the values ΔRₙ, ΔGₙ and ΔBₙ are simultaneously larger than the corresponding set values, the relationship between ΔRₙ, ΔGₙ and ΔBₙ is calculated to obtain the color of the corresponding clothing fading and inform users.

The embodiments in the above described may be further combined or replaced and the description is only preferred embodiments of the disclosure but not intended to be limited to the spirit and scope of the present disclosure. It should be noted that without departing from the design concept of the present disclosure, various variations and improvements made to the technical solutions of the present disclosure by persons skilled in the art all belong to the protection scope of the present disclosure.

1. A washing machine having a reminding function for preventing clothing from fading comprising an outer tub for washing water,
wherein the washing machine is provided with a color sensor for detecting color of washing water to determine whether or not the clothing fades depending on color change of the washing water during a washing process.

2. The washing machine according to claim 1, wherein the washing machine is equipped with a LED light emitting a white detection light which corresponds with the color sensor,
the white detection light emitted by the LED light passes through the washing water to the color sensor, and the color sensor obtains the color of the washing water based on a received detection light color.

3. The washing machine according to claim 1, wherein a bottom of the outer tub is provided with a sampler which communicates with the outer tub for influent of the washing water,
both side walls of the sampler are equipped with a LED light and the color sensor respectively,
a white detection light emitted by the LED light passes through the washing water in the sampler to the color sensor, and the color sensor obtains the color of the washing water based on a received detection light color.

4. The washing machine according to claim 3, wherein the sampler is arranged on a drain pipe or a circulation pipe of the washing machine,
the sampler is arranged upstream of a control device which controls an opening and closing of the drain pipe or the circulation pipe, and
the washing water in the outer tub is controlled to flow outside the washing machine through the sampler or flow into the washing machine though an inlet.

5. The washing machine according to claim 3, wherein the sampler comprises a housing configured a chamber for receiving a certain amount washing water,
an upper end of the housing is provided with a water inlet connected with the outer tub, a lower end of the housing is communicated with the drain pipe or the circulating pipe of the washing machine through a connecting pipe,
the connecting pipe is provided with a control device for controlling the opening and closing of the pipeline.

6. The washing machine according to claim 5, wherein the LED light and the color sensor are relatively provided on left and right side walls of the housing of the sampler to detect the color of the washing water in the sampler,
a portion of the housing corresponding to the LED light and a portion of the housing corresponding to the color sensor are respectively a transparent portion made of a light-transmitting plate.

7. The washing machine according to claim 6, wherein a bowl-shaped reflective plate is provided around a periphery of the LED light which reflects a divergent white light emitted from the LED light as a parallel light to a receiving component,
a convex lens is provided between the color sensor and the light-transmitting plate on a corresponding side, and the parallel detection light passing through the washing water is focused to the color sensor.

8. The washing machine according to claim 7, wherein a lens hood made of an opaque material is provided around an outer periphery of the color sensor,
preferably, the lens hood and the light-transmitting plate on the corresponding side constitute an enclosed chamber for placing the receiving component,
further preferably, the housing of the sampler is made of opaque material to form a shading portion.

9. The washing machine according to claim 1, wherein the color sensor comprises a detection element and filters which filter red, green and blue colors respectively, so as to obtain a value of red color R, a value of green color G, and a value of blue color B that are contained in the washing water.

10. The washing machine according to claim 9, wherein all the filters are provided on a side of the detection element facing the detection light,
the red filter, the green filter and the blue filter are respectively provided in different areas so that the detection element receives the detection light containing only red light, green light and blue light after filtration.

11. A reminding method of a washing machine for preventing clothing from fading, comprising, during a washing process of a washing machine, the washing machine detecting a color value of the washing water;
when a change rate of a color value of the washing water is greater than a set value, issuing an alarm of clothing color fading.

12. The reminding method of a washing machine for preventing clothing from fading according to claim 11, wherein, during the washing process, the color of the washing water in the outer tub of the washing machine is detected at a regular time interval t to get the color value of the washing water.

13. The reminding method of a washing machine for preventing clothing from fading according to claim 11, wherein, during the washing process, a small amount of washing water in the outer tub of the washing machine flows out at a regular time interval t and the color of the outflowing washing water is detected to get the color value of the washing water at this time.

14. The reminding method of a washing machine for preventing clothing from fading according to claim 13, wherein, the washing water in the sampler which is communicated with the outer tub of the washing machine is refreshed at a regular time interval t, and color of a refreshing washing water is detected by using the LED light and the color sensor which are arranged at the sampler,
preferably, the control device at a water outlet of the sampler is open for a certain time t1 at a regular time interval t, to drain the washing water in the sampler out, and allow the washing water in the outer tub to flow in through the water inlet of the sampler to refresh the washing water in the sampler.

15. The reminding method of a washing machine for preventing clothing from fading according to claim 11, comprising,
1) comparing the color change rate of the washing water to a set value, if the change rate is smaller than the set value, running step 4), if the change rate is greater or equal to the set value, running step 2);
2) the washing machine alarming to users about clothing color fading and stopping washing, and running step 3);
3) the user determining whether or not to go on washing, if yes, running step 4), if no, running step 5);
4) the washing machine continuing proceeding the washing process; after a certain time t, running step 1) until the washing process ends, and then running step 5);
5) the washing machine proceeding draining, dewatering in turn; after the dewatering process ends, the washing machine being turned off.

16. The reminding method of a washing machine for preventing clothing from fading according to claim 15, wherein,
after the control device is closed, the LED light and the color sensor at the sampler are turned on, and the color of the refreshing washing water is detected,
after the detection is completed, the LED light and the color sensor are turned off.

17. The reminding method of a washing machine for preventing clothing from fading according to claim 16, wherein,
a specific determination process is as followed, the LED emits white detection light to the washing water in the sampler; the color of the detection light is changed after passing through the washing water; the color sensor receives the detection light though the washing water to determine the color of the washing water according to the color of the detection light received,
preferably, the color sensor let the detection light which passes though the washing water and of which color has been changed respectively pass through red, green and blue three colors filters to get the color value of the red color R, the color value of the green color G, the color value of the blue color B that are contained in the washing water.

18. The reminding method of a washing machine for preventing clothing from fading according to claim 11, comprising,
11) detecting the color value of the red color R, the color value of the green color G, the color value of the blue color B at a regular time interval t;
12) the color values Rₙ, Gₙ, and Bₙ detected this time being correspondingly subtracted previously detected color value values Rₙ₋₁, Gₙ₋₁ and Bₙ₋₁ to obtain ΔRₙ=|Rₙ−Rₙ₋₁|, ΔGₙ=|Gₙ−Gₙ₋₁|, ΔBₙ=|Bₙ−ₙ₋₁|;
13) comparing color change values ΔRₙ, ΔGₙ, ΔBₙ to corresponding set values ΔR′, ΔG′, ΔB′,
if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

19. The reminding method of a washing machine for preventing clothing from fading according to claim 11, comprising,
21) during a water supplying process, or after the water supplying process and before the washing process, detecting the color of the washing water and getting initial color values R₀, G₀, B₀ of red, green and blue colors which is contained in the washing water;
22) during the washing process, respectively detecting the color value of the red color R, the color value of the green color G, the color value of the blue color B contained in the washing water at a regular time interval t;
23) the color values Rₙ, Gₙ, and Bₙ detected this time being correspondingly subtracted the initial color values R₀, G₀, B₀ before washing process to obtain ΔRₙ=|Rₙ−R₀|, ΔGₙ=|Gₙ−G₀|, ΔBₙ=|Bₙ−B₀|;
24) comparing color change values ΔRₙ, ΔGₙ, ΔBₙ to corresponding set values ΔR′, ΔG′, ΔB′,
if ΔRₙ>ΔR′ and/or ΔGₙ>ΔG′ and/or ΔBₙ>ΔB′, the washing machine issuing a fading alarm signal and stopping washing, otherwise, the washing machine normally performing the washing process.

20. The reminding method of a washing machine for preventing clothing from fading according to claim 18, comprising
when ΔRₙ>ΔR′, the washing machine issuing a red alarm of clothing color fading,
when ΔGₙ>ΔG′, the washing machine issuing a green alarm of clothing color fading, when ΔBₙ>ΔB′, the washing machine issuing a blue alarm of clothing color fading.
